(19) United States
(12) Patent Application Publication
(10) Pub. No.: US 2026/0295479 A1
(43) Pub. Date: Oct. 1, 2026

(54) FILTRATION APPARATUS AND METHOD OF CONTROLLING FILTRATION APPARATUS

(71) Applicant: RENASYS AS, FØRDE (NO)

(72) Inventors: Trond MELHUS, Sandnes (NO); Arne MALMIN, Sandnes (NO)

(73) Assignee: RENASYS AS, FØRDE (NO)

(21) Appl. No.: 19/484,038

(22) PCT Filed: Apr. 10, 2024
(86) PCT No.: PCT/EP2024/059708

§ 371 Date: Nov. 13, 2025

(30) Foreign Application Priority Data
May 22, 2023 (SE) 2350607-4

(51) Int. Cl. B01D 33/067; B01D 33/11; B01D 33/80; B01D 36/00; B01D 37/04

(52) U.S. Cl. CPC B01D 33/067; B01D 33/11; B01D 33/801; B01D 36/001; B01D 37/04; B01D 2201/204; B01D 2201/347

(57) ABSTRACT

A filtration apparatus for filtering liquid, the filtration apparatus comprising a stationary base structure; a drum comprising a central drum axis and being rotatable inside and relative to the base structure about the drum axis, the drum defining an interior volume for receiving liquid from an upstream section and comprising at least one filter element for filtering liquid passing from the interior volume to a downstream tank downstream of the drum; and a plurality of sealing elements arranged to seal radially between the drum and the base structure with respect to the drum axis in each rotational position of the drum with respect to the drum axis. A method of controlling a filtration apparatus is also provided.

### TECHNICAL FIELD

The present disclosure generally relates to filtration of liquids. In particular, a filtration apparatus for filtering liquid, and a method of controlling a filtration apparatus, are provided.

### BACKGROUND

A wide range of filtration apparatuses for filtrating liquid exist, for example to filtrate wastewater. Some filtration apparatuses comprise one or more filter elements that move during filtration. A filtration apparatus may for example be of the drum filter type where one or more filter elements are provided at a circumference of a rotating drum. To this end, a plurality of filter panels may be mounted on the drum, where each filter panel carries a filter element.

WO 2016207143 A1 discloses a drum filter for filtering liquid. The drum filter comprises an inlet, an outlet and a drum including a plurality of filter panels.

### SUMMARY

One object of the invention is to provide an improved filtration apparatus.

A further object of the invention is to provide an improved method of controlling a filtration apparatus.

These objects are achieved by the filtration apparatus according to appended claim 1 and the method according to appended claim 14.

The invention is based on the realization that by providing a filtration apparatus comprising a plurality of sealing elements radially between a rotatable drum filter and a stationary base structure, performance of the filtration apparatus can be improved.

According to a first aspect, there is provided a filtration apparatus for filtering liquid, the filtration apparatus comprising a stationary base structure; a drum comprising a central drum axis and being rotatable inside and relative to the base structure about the drum axis, the drum defining an interior volume for receiving liquid from an upstream section and comprising at least one filter element for filtering liquid passing from the interior volume to a downstream tank downstream of the drum; and a plurality of sealing elements arranged to seal radially between the drum and the base structure with respect to the drum axis in each rotational position of the drum with respect to the drum axis.

By virtue of the sealing elements, ambient air may be prevented, or may be substantially prevented, from entering the downstream tank via a space radially between the drum and the base structure with respect to the drum axis. The filtration apparatus therefore enables provision of an underpressure in the downstream tank. For example, an atmospheric pressure may prevail in the interior volume and/or in the upstream section, and an underpressure, e.g., substantially lower than the atmospheric pressure, may prevail in the downstream tank. In this way, the filtration apparatus enables provision of a substantial pressure drop over the one or more filter elements, which significantly improves a performance of filtration of the liquid.

In case an underpressure, with respect to a pressure in the interior volume, is established in the downstream tank, the sealing elements enable maintaining this underpressure during rotation of the drum. During operation of the filtration apparatus, the drum rotates about the drum axis and an upstream level of the liquid in the interior volume may be higher than a geodetically lowest sealing element in contact with the base structure on each side of the drum, for each rotational position of the drum with respect to the drum axis. In some variants, the upstream level is above the drum axis during operation of the filtration apparatus. For each rotational position of the drum with respect to the drum axis, at least two of the sealing elements, such as one sealing element on each side of the drum, may seal radially between the drum and the base structure.

The filtration apparatus of the first aspect also has excellent scalability. For example, the filtration apparatus can relatively easily be rebuilt to be longer or shorter along the drum axis to increase or decrease, respectively, a filtration capacity of the filtration apparatus. As a further example, the drum can also more easily be replaced with a new drum of different diameter. Such replacement may in some examples also comprise replacing first and second base elements of the base structure.

The drum may comprise a frame. The drum may be cylindrical. In this case, the drum axis may be concentric with the drum.

The drum may further comprise a plurality of filter panels secured to the frame. Each filter panel may comprise one filter element. Each filter panel may be detachably attached to the frame. The plurality of sealing elements and the plurality of filter panels may be alternatingly arranged in a circumferential direction of the drum with respect to the drum axis. That is, each sealing element may be provided at a junction between two adjacent filter panels.

With respect to a flow direction through the filtration apparatus, the interior volume is arranged between the upstream section and the downstream tank. Each sealing element may be elastic. To this end, each sealing element may for example have a Young's modulus of at least 1 MPa, such as at least 2 MPa. Alternatively, or in addition, each sealing element may comprise, or be constituted by, rubber.

Each sealing element may be elongated and oriented substantially parallel with, or parallel with, the drum axis.

The filtration apparatus may further comprise the downstream tank. In these cases, the filtration apparatus may be configured to provide an underpressure in the downstream tank with respect to an atmospheric pressure. To this end, the downstream tank may be substantially closed to atmosphere. With substantially closed to atmosphere may be meant that a pressure exchange between the downstream tank and the atmosphere is controlled. The downstream tank may for example be substantially closed to the atmosphere in that, except for a gas outlet device and an outlet line associated with the downstream tank, the downstream tank is closed to atmosphere. When the downstream tank is substantially closed to atmosphere, the filtration apparatus enables controlling a differential pressure over the at least one filter element, for example by controlling a downstream level of the liquid in the downstream tank. That is, for a given design of the downstream tank, a reduction of the downstream level causes an increase of the differential pressure over the at least one filter element.

The filtration apparatus may further comprise a liquid outlet device configured to control an outlet flow of the liquid out from the downstream tank, and a gas outlet device configured to control a gas flow out from the downstream tank. By virtue of the sealing elements, the downstream tank is closed to atmosphere except for the controllable liquid outlet device and the gas outlet device.

The liquid outlet device may be of various types, for example an outlet valve. By controlling the liquid outlet device, the underpressure of the liquid in the downstream tank can be controlled.

The gas outlet device may be of various types, for example a vacuum pump. By controlling the gas outlet device, the underpressure of the liquid in the downstream tank can be controlled.

The sealing elements may be fixed to the drum. The sealing elements may be circumferentially arranged with respect to the drum axis. The sealing elements may be evenly distributed around a circumference of the drum around the drum axis. When the sealing elements are fixed to the drum, the filtration apparatus or the drum may comprise at least six sealing elements, such as eight sealing elements.

The base structure may comprise a first base element and a second base element on opposite sides of the drum. In these cases, the sealing elements may seal radially between the drum and the base elements. The first and second base elements may be arranged opposite to the drum with respect to a horizontal direction transverse to the drum axis. Moreover, the first and second base elements may have a mirrored design with respect to a plane comprising the horizontal direction as a normal thereto. Each base element may comprise at least one curved portion substantially concentric with, or concentric with, the drum axis.

Each base element may have an angular extension with respect to the drum axis that is equal to, or larger than, a maximum angular extension between two adjacent sealing element with respect to the drum axis. An angular extension of each base element may for example be at least 60 degrees, such as 90 degrees, with respect to the drum axis.

Each base element may comprise a plate.

For one of the base elements, the base element may comprise a bulge protruding away from the drum axis such that for at least one rotational position of the drum with respect to the drum axis, two of the sealing elements are in contact with the base element on opposite sides of the bulge. In these examples, each base element may comprise two curved portions substantially concentric with, or concentric with, the drum axis, and the bulge may be positioned circumferentially between the two curved portions with respect to the drum axis.

For each rotational position of the drum about the drum axis, two of the sealing elements sealing radially between the drum and the base elements may be positioned below the drum axis.

The drum may comprise a first end and a second end along the drum axis. In these cases, each filter element may be positioned between the first end and the second end. Moreover, in these cases, each sealing element and the base structure may extend substantially in parallel with the drum axis from the first end to the second end.

The filtration apparatus may further comprise at least one wheel, each wheel being rotatable about a wheel axis substantially parallel with, or parallel with, the drum axis. In these cases, the drum may rest on the at least one wheel.

These variants are substantially different from prior art filtration apparatuses where the drum is supported by a central support shaft concentric with the drum axis. Each wheel may be positioned radially outside of the drum with respect to the drum axis and/or geodetically below the drum axis. The filtration apparatus may comprise only one or a plurality of such wheel axes.

According to one example, the filtration apparatus comprises one or more wheels rotatable about a first wheel axis substantially parallel with, or parallel with, the drum axis, and one or more wheels rotatable about a second wheel axis substantially parallel with, or parallel with, the drum axis. In this case, the first and second wheel axis may be offset from each other. With this variant, drums of different diameters can efficiently be supported by the wheels.

The combination of the sealing elements and the drum resting on the at least one wheel generates several advantages. For example, this combination enables the drum to self-adjust during rotation of the drum, e.g., based on individual properties of the sealing elements, such as radial dimensions of the sealing elements with respect to the drum axis. The self-adjustment may comprise movements of the drum in directions transverse to the drum axis.

Such self-adjustment is not possible with a drum supported on a central support shaft concentric with the drum axis. When using such central port shaft, the sealing elements instead have to be adjusted based on the fixed position of the drum.

The filtration apparatus may further comprise a drive motor arranged to drive the at least one wheel about the respective wheel axis for rotating the drum about the drum axis. To this end, each wheel may contact and frictionally engage the drum. For example, one or more wheels may contact the first end and one or more wheels may contact the second end. The variant of this aspect enables a substantially lower torque to be provided to rotate the drum in comparison with a driven central support shaft according to the prior art. As a consequence, operational efficiency of the filtration apparatus is improved.

One or more wheels may be arranged on a first shaft and one or more wheels may be arranged on the second shaft, parallel with the first shaft. The first and second shafts may be substantially parallel with, or parallel with, the drum axis. In such variants, the drive motor may drive the first shaft, directly or indirectly via a motor transmission, and the second shaft may be driven by the first shaft via an intermediate transmission, such as a belt or a chain. The filtration apparatus may comprise more or fewer than two shafts with associated wheels thereon.

As an alternative, or an addition, to the wheels, the filtration apparatus may comprise a central support shaft concentric with the drum axis. In this case, the central support shaft may be supported on bearings outside the drum. The central support shaft may be fixed to the first and second ends of the drum.

The drum may further comprise a plurality of lifting elements. The lifting elements may be configured to lift residue collected on one or more of the at least one filter element during rotation of the drum. Each lifting element may be elongated and parallel with the drum axis. Each lifting element may protrude radially inwards with respect to the drum axis, such as radially inwards from the frame. In case the sealing elements are fixed to the drum, each lifting element may be circumferentially aligned with an associated sealing element with respect to the drum axis. Moreover, a length of each lifting element in parallel with the drum axis may be substantially the same (e.g., less than 10% difference), or the same, as a length of each sealing element.

The filtration apparatus may further comprise a collection element for collecting residue. The collection element may be arranged at least partially inside the drum. According to some examples, the collection element extends along substantially the entire drum, or along the entire drum, in parallel with the drum axis. The lifting elements may be arranged to lift residue to a position above the collection element. At this position, the residue may fall into the collection element by gravity. The filtration apparatus may further comprise a feed device, such as a feed screw, for transporting residue in the collection element out from the drum.

According to a second aspect, there is provided a method of controlling a filtration apparatus, the method comprising providing a filtration apparatus according to the first aspect; conducting a liquid through the at least one filter element while rotating the drum around the drum axis; and controlling a differential pressure of the liquid through the at least one filter element. The filtration apparatus of the second aspect may be of any type described in connection with the first aspect, and vice versa.

The control of the differential pressure may comprise controlling a rotational speed of the drum about the drum axis.

The provision of the filtration apparatus may comprise providing a filtration apparatus comprising a liquid outlet device configured to control an outlet flow of the liquid out from the downstream tank, and a gas outlet device configured to control a gas flow out from the downstream tank. In these cases, the control of the differential pressure may comprise controlling the liquid outlet device to control the outlet flow and/or controlling the gas outlet device to control the gas flow. The differential pressure may be controlled in alternative and/or additional ways, for example by controlling an upstream level of the liquid in the upstream region.

### BRIEF DESCRIPTION OF THE DRAWINGS

Further details, advantages and aspects of the present disclosure will become apparent from the following description taken in conjunction with the drawings, wherein:

FIG. 1: schematically represents a perspective side view of a filtration apparatus;

FIG. 2: schematically represents a perspective side view of a drum of the filtration apparatus;

FIG. 3: schematically represents a further perspective partial side view of the filtration apparatus;

FIG. 4: schematically represents a cross-sectional end view of the filtration apparatus;

FIG. 5: schematically represents a further cross-sectional end view of the filtration apparatus;

FIG. 6: schematically represents a further side view of the filtration apparatus;

FIG. 7: schematically represents a cross-sectional end view of a filtration apparatus according to a further example; and

FIG. 8: is a flowchart outlining general steps of a method.

### DETAILED DESCRIPTION

In the following, a filtration apparatus for filtering liquid, and a method of controlling a filtration apparatus, will be described. The same or similar reference numerals will be used to denote the same or similar structural features.

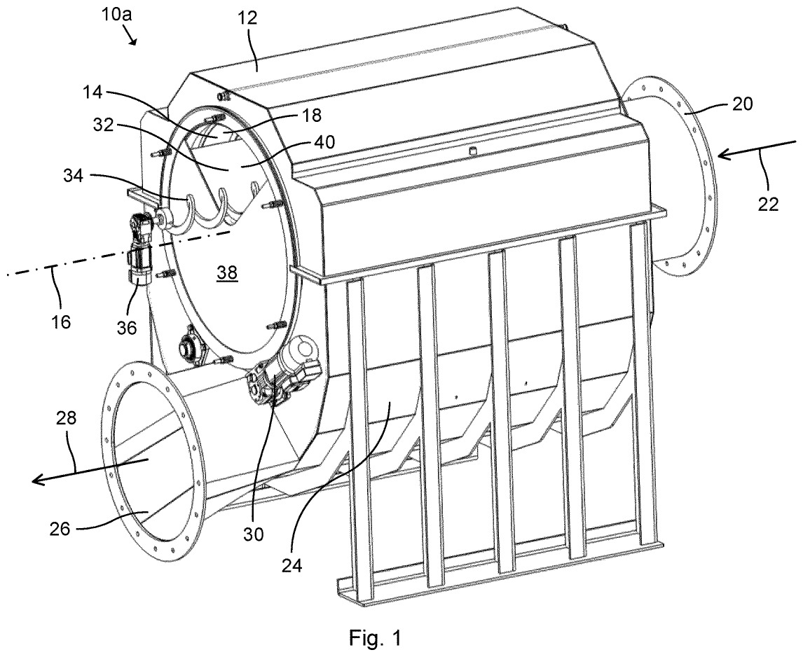

FIG. 1 schematically represents a perspective side view of a filtration apparatus 10a according to one example. The filtration apparatus 10a of this example is arranged to filtrate liquid, such as water, such as wastewater.

The filtration apparatus 10a comprises a stationary base structure 12 and a drum 14. In this example, the base structure 12 is embodied as a housing. The drum 14 is positioned inside the base structure 12. The drum 14 comprises a drum axis 16. The drum axis 16 is centered in the drum 14. The drum 14 is rotatable about the drum axis 16 relative to the base structure 12. The drum 14 defines an interior volume 18 inside the drum 14.

The filtration apparatus 10a of this example further comprises an upstream section 20 for receiving an inlet flow 22 of water. The upstream section 20 is arranged to pass this inlet flow 22 to the interior volume 18. The upstream section 20 is thus an inlet to the drum 14. The upstream section 20 is here exemplified as comprising a pipe, but may be realized in many alternative ways. During operation of the filtration apparatus 10a of this example, atmospheric pressure prevails in the upstream section 20 and in the interior volume 18.

The filtration apparatus 10a of this example further comprises a downstream tank 24. The downstream tank 24 of this example comprises an outlet line 26. The outlet line 26 is arranged to conduct an outlet flow 28 of water out from the filtration apparatus 10a. The downstream tank 24 provides a downstream section downstream of the drum 14. With respect to a flow direction of water through the filtration apparatus 10a, the interior volume 18 is arranged between the upstream section 20 and the downstream tank 24. During operation of the filtration apparatus 10a of this example, an underpressure lower than the atmospheric pressure can prevail in the downstream tank 24.

The filtration apparatus 10a of this example further comprises a drive motor 30, such as an electric motor. The drive motor 30 is arranged to drive rotation of the drum 14 about the drum axis 16.

The filtration apparatus 10a of this example further comprises a collection element 32 for collecting residue. The collection element 32 is here arranged inside the drum 14.

The filtration apparatus 10a of this example further comprises a feed device, here in the form of a feed screw 34. By rotating the feed screw 34, residue in the collection element 32 can be forced out from the base structure 12.

The filtration apparatus 10a of this example further comprises a feed motor 36, such as an electric motor. The feed motor 36 is arranged to drive rotation of the feed screw 34.

The filtration apparatus 10a of this example further comprises an end cover 38. The end cover 38 here forms a part of the base structure 12. The end cover 38 comprises an opening 40. A lifting tool (not shown) can be inserted through the opening 40 and into the drum 14. The entire drum 14 can thereby be lifted out from the base structure 12, e.g., for service, maintenance or repair of the drum 14.

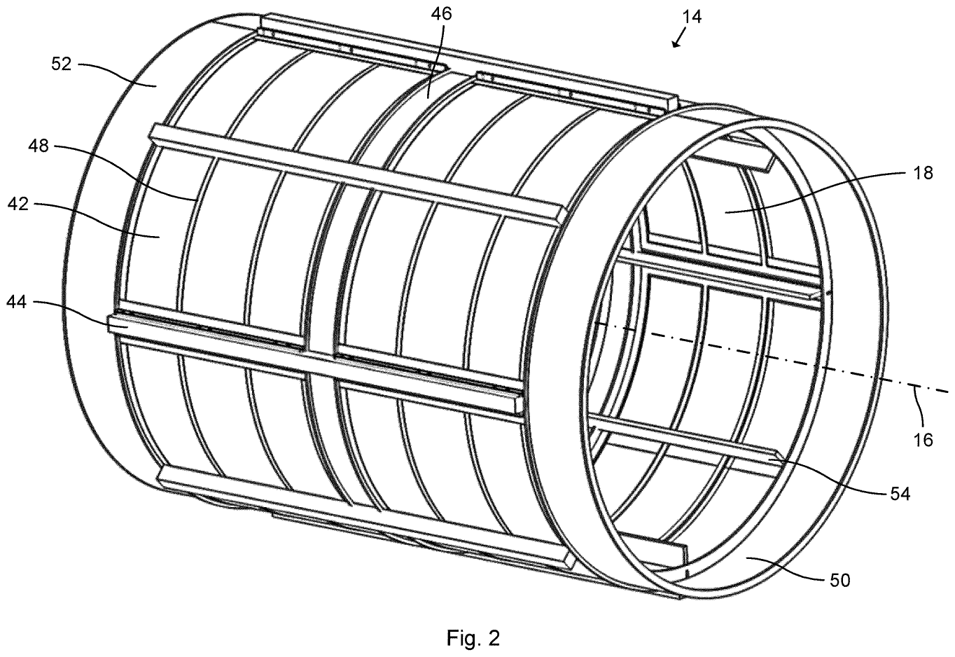

FIG. 2 schematically represents a perspective side view of the drum 14. The drum 14 of this example comprises a plurality of filter elements 42. Each filter element 42 is configured to filter water or other liquid passing from the interior volume 18 to the downstream tank 24.

Each filter element 42 may comprise a wire cloth, such as a metal wire cloth or alloy wire cloth, having a three-dimensional pore geometry. The wire cloth may comprise warp wires and weft wires crossing each other and interwoven by a weave pattern. The warp wires may be formed in at least two different configurations to define warp wires of first and second types. A length of the first type of warp wires may deviate from a length of the second type of warp wires in relation to a particular length unit. Pores may be formed in interstices between sections of two neighbouring warp wires and crossing sections of two neighbouring weft wires.

The drum 14 further comprises a plurality of sealing elements 44, here eight sealing elements 44. The sealing element 44 are arranged to seal radially between the drum 14 and the base structure 12 with respect to the drum axis 16.

Each sealing element 44 is elongated and oriented in parallel with the drum axis 16. The sealing elements 44 are evenly distributed around a circumference of the drum 14 around the drum axis 16. Thus, in this example comprising eight sealing elements 44, an angular spacing between each pair of circumferentially adjacent sealing elements 44 is 45 degrees. Each sealing element 44 is elastic, for example by being made of rubber having a Young's modulus of around 3 MPa.

The drum 14 of this example comprises a frame 46. As shown, the frame 46 of this example is cylindrical and concentric with the drum axis 16. The drum 14 may have a diameter of at least 1 m, and/or less than 3 m, such as 1600 mm or 2000 mm. The sealing elements 44 are fixed to the frame 46. Moreover, each sealing element 44 of this example protrudes radially outwards with respect to the drum axis 16, e.g., from the frame 46. The frame 46 may be made of metal, such as steel.

The drum 14 of this example further comprises a plurality of filter panels 48. As shown in FIG. 2, the sealing elements 44 and the filter panels 48 are alternatingly arranged in a circumferential direction of the drum 14 with respect to the drum axis 16.

Each filter panel 48 here comprises one of the filter elements 42. Each filter panel 48 is secured to the frame 46. In the non-limiting example illustrated in FIG. 2, sets of six filter panels 48 are arranged in the axial direction of the drum 14, i.e., along the drum axis 16. The drum 14 may comprise more or fewer filter panels 48 in the axial direction of the drum 14. Each filter panel 48 may for example have a width of 30 cm to 50 cm. A length of the drum 14 in the axial direction may for example be at least 3 m, such as 4 m to 5 m.

Each filter panel 48 may for example be constituted by a filter panel as described in Swedish patent application SE2350298-2, the entire content of which is incorporated herein by reference. In case one filter element 42 is damaged, only the filter panel 48 comprising the damaged filter element 42 may be replaced.

The drum 14, here the frame 46 thereof, comprises a first end 50 and a second end 52, here embodied as two rings. The first end 50 and the second end 52 are separated from each other along the drum axis 16. As shown in FIG. 2, all filter panels 48 are positioned between the first end 50 and the second end 52. Each sealing element 44 here extends from the first end 50 to the second end 52.

The drum 14 of this example further comprises a plurality of lifting elements 54. Each lifting element 54 is elongated and parallel with the drum axis 16.

Moreover, each lifting element 54 protrudes radially inwards with respect to the drum axis 16, e.g., from the frame 46. Each lifting element 54 is here embodied as a plate. Each lifting element 54 is circumferentially aligned with an associated sealing element 44 with respect to the drum axis 16. Moreover, each lifting element 54 here has the same length as the associated filter element 42.

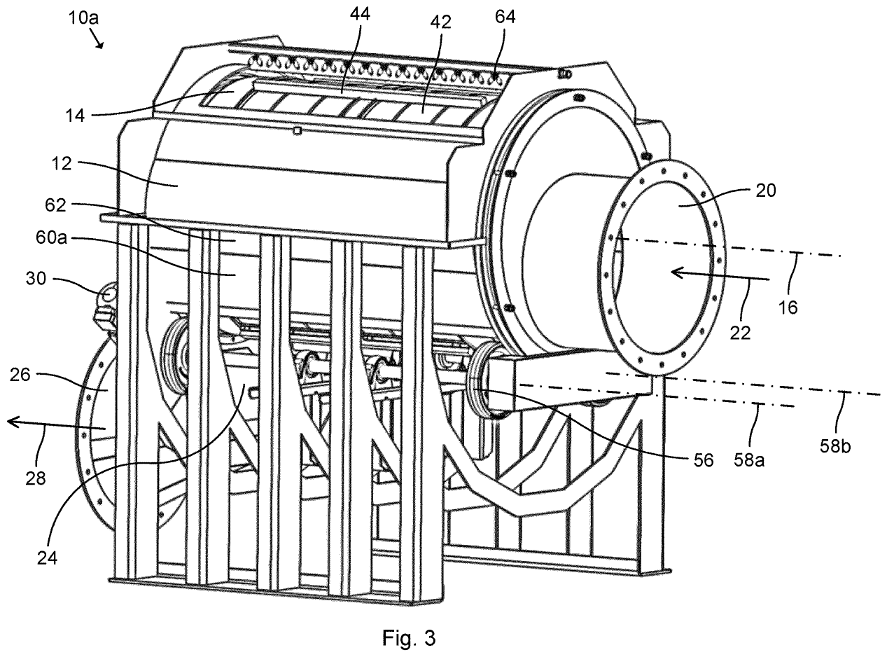

FIG. 3 schematically represents a further perspective partial side view of the filtration apparatus 10a. As shown, the filtration apparatus 10a of this example comprises a plurality of wheels 56, such as four wheels 56. Each wheel 56 is rotatable about a wheel axis parallel with the drum axis 16. FIG. 3 shows a first wheel axis 58a around which two of the wheels 56 are rotatable and a second wheel axis 58b around which two of the wheels 56 are rotatable.

In this example, two wheels 56, one at the first wheel axis 58a and one at the second wheel axis 58b, are in contact with and frictionally engages the first end 50. Correspondingly, two wheels, one at the first wheel axis 58a and the second wheel axis 58b, are in contact with and frictionally engages the second end 52. Each wheel 56 is thus positioned radially outside of drum 14 with respect to the drum axis 16. Moreover, in this example, each wheel 56 is positioned geodetically below the drum axis 16.

The drum 14 rests on the wheels 56 by gravity. The entire weight of the drum 14 and of liquid inside the drum 14 is carried by the wheels 56 below the drum 14. The weight of the liquid inside the drum 14 may amount to the liquid volume in the interior volume 18 that is above a downstream level, i.e., a level of the liquid in the downstream tank 24. This weight may be substantial. In prior art solutions where the a drum is supported by a central support shaft (concentric with the drum axis), this support shaft carries the entire weight of the drum and of the liquid inside the drum. In such solutions, the support shaft imposes limitations on a maximum length of the drum. Since the support principle of the filtration apparatus 10a using the wheels 56 below the drum 14 shown in FIG. 1 is substantially stronger, the drum 14 can more easily be made longer, either without altering the support or by adding one or more further wheels 56.

Moreover, the support of the filtration apparatus 10a using the wheels 56 below the drum 14 enables the entire drum 14 to be lifted out from the filtration apparatus 10a more easily, for example for maintenance, repair or replacement.

Each wheel 56 contacts the drum 14 at a respective contact interface. Each contact interface may be a resilient contact interface. Such resilient contact interface may for example be obtained by elastic properties of the wheels 56 and/or by an elastic suspension of the wheels 56.

As can be gathered from FIG. 3, each contact interface between the drum 14 and the wheels 56 is positioned at a circumference of the drum 14. This means that relatively low torques are needed on each wheel 56 to drive rotation of the drum 14 in comparison with a torque required for a central support shaft supporting the drum according to the prior art. The filtration apparatus 10a is therefore more energy efficient in comparison with prior art solutions.

In FIG. 3, it can be seen that the base structure 12 of this example comprises a first base element 60a. The first base element 60a of this example in turn comprises a bulge 62.

FIG. 3 further shows that the filtration apparatus 10a of this example further comprises a cleaning device 64. The cleaning device 64 is configured to clean passive filter elements 42, i.e. filter elements 42 outside a filtration area of the drum 14. The cleaning device 64 is configured to force filtride or residue away from the filter elements 42. To this end, the cleaning device 64 may for example comprise a plurality of air knives.

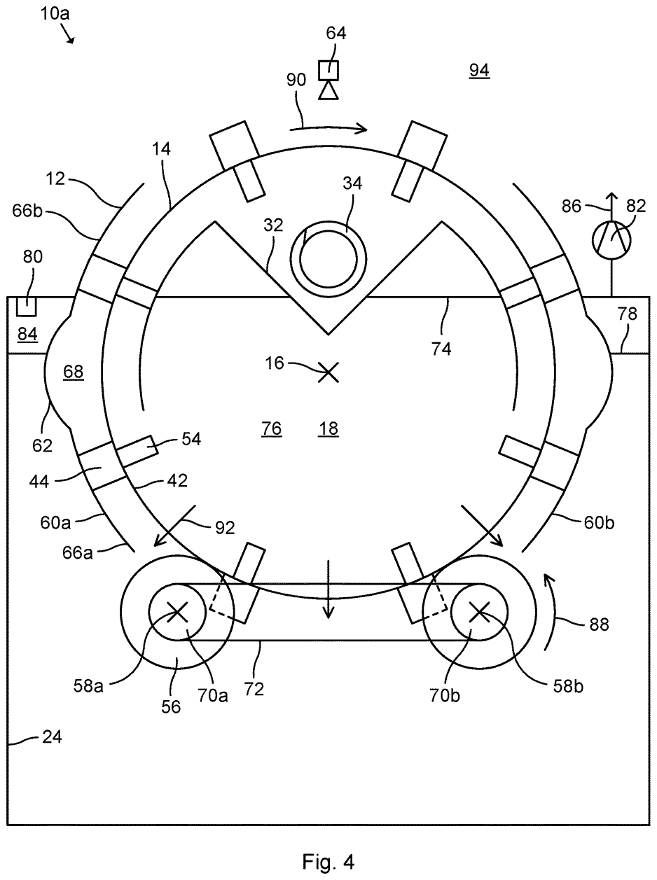

FIG. 4 schematically represents a cross-sectional end view of the filtration apparatus 10a. FIG. 4 shows that in addition to the first base element 60a, the base structure 12 of this example further comprises a second base element 60b. The base elements 60a, 60b are arranged on horizontally opposite sides of the drum 14 and here have mirrored designs. The base elements 60a, 60b extend in parallel with the drum axis 16 from the first end 50 to the second end 52. In this example, each of the base elements 60a, 60b is a plate. The base elements 60a, 60b may however be realized in alternative ways.

In addition to the bulge 62, each of the base elements 60a, 60b comprises a first curved portion 66a and a second curved portion 66b. Each of the curved portions 66a, 66b is concentric with the drum axis 16. For each base element 60a, 60b, the bulge 62 is positioned circumferentially between the curved portions 66a, 66b with respect to the drum axis 16. Each bulge 62 protrudes away from the drum axis 16. In this example, the bulge 62 of the first base element 60a is curved to be concentric about an imaginary axis horizontally between the drum axis 16 and the first base element 60a. Correspondingly, the bulge 62 of the second base element 60b is curved to be concentric about an imaginary axis horizontally between the drum axis 16 and the second base element 60b.

In this specific and non-limiting example, each base element 60a, 60b has an angular extension with respect to the drum axis 16 of 90 degrees. The angular spacing between the sealing element 44 on the other hand, are 45 degrees in this example.

FIG. 4 further shows that a space 68 is provided between drum 14 and the first base element 60a and between the drum 14 and the second base element 60b. Each space 68 is a radial space with respect to the drum axis 16.

FIG. 4 further shows that the filtration apparatus 10a of this example comprises a first shaft 70a to which one or more wheels 56 are fixed, and a second shaft 70b to which one or more wheels 56 are fixed. The first shaft 70a and the second shaft 70b are rotatable around the first wheel axis 58a and the second wheel axis 58b, respectively. Although FIG. 4 illustrates the first wheel axis 58a and the second wheel axis 58b at the same height, the first wheel axis 58a and the second wheel axis 58b may alternatively be arranged at different heights.

FIG. 4 further shows that the filtration apparatus 10a of this example comprises a belt 72. The belt 72 is wound around the first shaft 70a and the second shaft 70b. The belt 72 is one example of an intermediate transmission according to the present disclosure. In this example, the drive motor 30 may drive rotation of the first shaft 70a. Rotation of the first shaft 70a is in turn transmitted to a rotation of the second shaft 70b by the belt 72.

FIG. 4 further shows an upstream level 74 of water 76 in the upstream section 20 and the interior volume 18, and a downstream level 78 of water 76 in the downstream tank 24. FIG. 4 also shows a downstream level sensor 80 arranged to measure the downstream level 78 of the water 76 in the downstream tank 24.

FIG. 4 further shows that the filtration apparatus 10a of this example comprises a vacuum pump 82. The vacuum pump 82 is one example of a gas outlet device according to the present disclosure. The vacuum pump 82 is configured to suck gases 84 out from the top of the downstream tank 24 to thereby evacuate the gases 84. By controlling the vacuum pump 82, a gas flow 86 out from the downstream tank 24 can be controlled. The vacuum pump 82 may be positioned in, and connected to, a geodetically highest region of the downstream tank 24.

As shown in FIG. 4, each sealing element 44 is arranged to seal radially between the drum 14 and the first base element 60a and radially between the drum 14 and the second base element 60b. For each rotational position of the drum 14 about the drum axis 16, at least one sealing element 44 seals against the first base element 60a and at least one sealing element 44 seals against the second base element 60b. Each sealing element 44 in contact with one of the base elements 60a, 60b provides a barrier in the space 68 between the drum 14 and the respective base element 60a, 60b.

During operation of the filtration apparatus 10a, the drive motor 30 drives the first shaft 70a and the second shaft 70b to rotate about their respectively associated wheel axis 58a, 58b as shown with arrow 88. The wheels 56 thereby drives the drum 14 to rotate about the drum axis 16 as shown with arrow 90.

As shown in FIG. 4, the upstream level 74 may be higher than the downstream level 78 during operation of the filtration apparatus 10a. This causes an underpressure to be generated in the downstream tank 24. The pressure in the downstream tank 24 is thereby lower than a pressure in the interior volume 18, which is at atmospheric pressure. A height difference between the upstream level 74 and the downstream level 78 may for example be at least 3 cm, such as 5 cm to 7 cm. However, an underpressure can also be generated in the downstream tank 24 without any significant height difference between the upstream level 74 and the downstream level 78. As shown in FIG. 4, the upstream level 74 may be above the drum axis 16 during operation of the filtration apparatus 10a of this example.

At each rotational position of the drum 14, at least one of the filter elements 42 is active, meaning that water 76 currently passes therethrough for filtration, from the interior volume 18 to the downstream tank 24 as shown with arrows 92. Due to the differential pressure, the water 76 is pulled through the active filter elements 42 as shown with arrows 92. In the specific rotational position of the drum 14 in FIG. 4 and for this specific cross-section, there are three active filter elements 42. Since at least one sealing element 44 always seals against the first base element 60a and at least one sealing element 44 always seals against the second base element 60b, ambient air 94 is prevented from entering into the downstream tank 24 via the spaces 68 between the drum 14 and the base elements 60a, 60b. Thus, a differential pressure over the active filter elements 42 can be maintained during rotation of the drum 14.

Filtration by a differential pressure over a filter element has been proven by the applicant to function very well. Reference can for example be made to international patent applications WO 2020164730 A1 and WO 2023274535 A1, the contents of which are incorporated herein by reference in their entirety. The differential pressure may for example be at least 100 mbar.

In this example, the drum 14 rests loosely on the wheels 56. During rotation of the drum 14, the drum 14 will always be in contact with at least one wheel 56. Should a contact between one or more of the wheels 56 be temporarily lost, the drum 14 can still be rotationally driven by one or more of the remaining wheels 56. The ability of the drum 14 to move somewhat relative to the base structure 12 for example enables the sealing elements 44 to be more evenly compressed to provide a self-adjusting effect. As a consequence, performance of the filtration apparatus 10a is improved.

Before one of the sealing elements 44 leaves the first base element 60a, another sealing element 44 is already in sealing contact with the first base element 60a. Correspondingly, before one of the sealing elements 44 leaves the second base element 60b, another sealing element 44 is already in sealing contact with the second base element 60b.

If the filtration apparatus 10a should not comprise the sealing elements 44, an established underpressure in the downstream tank 24 would cause a substantial amount of ambient air 94 to be drawn into the downstream tank 24. Due to the sealing elements 44, the underpressure in the downstream tank 24 causes an improved filtration through the filter elements 42.

During rotation of the drum 14, residue collected on the filter elements 42 are lifted by the lifting elements 54, here also in cooperation with the collection element 32. When a lifting element 54 is positioned above the collection element 32, the collected residue falls into the collection element 32 by gravity and/or under the influence of the cleaning device 64.

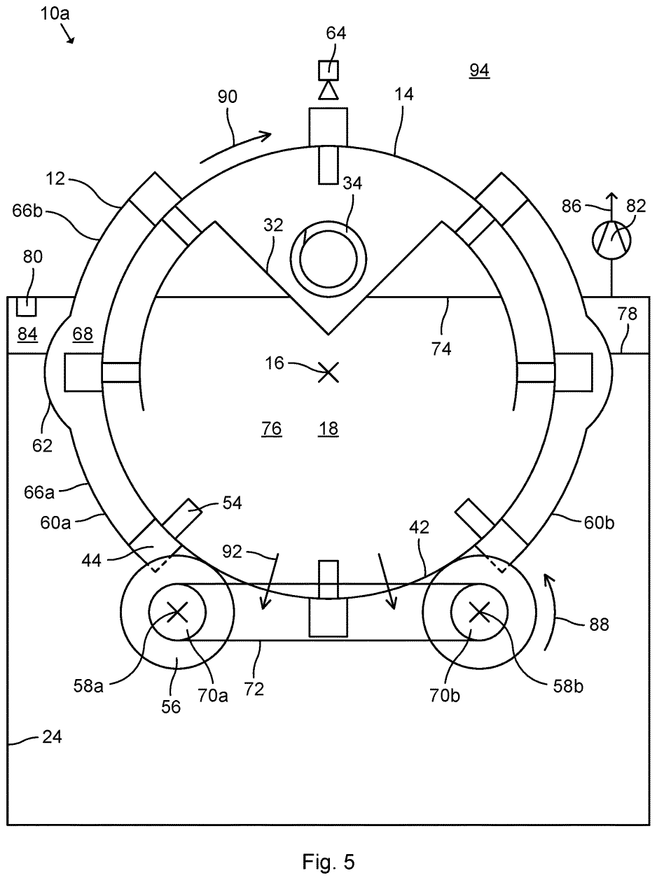

FIG. 5 schematically represents a further cross-sectional end view of the filtration apparatus 10a. In FIG. 5, the drum 14 is in a different rotational position around the drum axis 16 in comparison with in FIG. 4.

During rotation of the drum 14, some water 76 may also be lifted by the sealing elements 44 after entering into sealing engagement with the first base element 60a in the downstream tank 24. However, once the respective sealing element 44 becomes aligned with the bulge 62 of the first base element 60a as shown in FIG. 5, the sealing element 44 becomes temporarily disengaged from the first base element 60a to allow the water 76 to fall back into the downstream tank 24. As shown in FIG. 5, since at least one sealing element 44 is always sealing against the base elements 60a, 60b, no ambient air 94 will enter into the downstream tank 24 through the spaces 68. In the specific rotational position of the drum 14 in FIG. 5, one sealing element 44 is in contact with the first curved portion 66a and one sealing element 44 is contact with the second curved portion 66b. The bulge 62 of the second base element 60b is optional. In case this bulge 62 is omitted, performance when rotating the drum 14 in an opposite direction may be deteriorated.

As can be gathered from FIGS. 4 and 5, for each rotational position of the drum 14 about the drum axis 16, two of the sealing elements 44 sealing radially between the drum 14 and the base elements 60a, 60b are positioned geodetically below the drum axis 16 in this example. All filter elements 42 between these two sealing elements 44 and facing into the downstream tank 24 may be active filter elements 42.

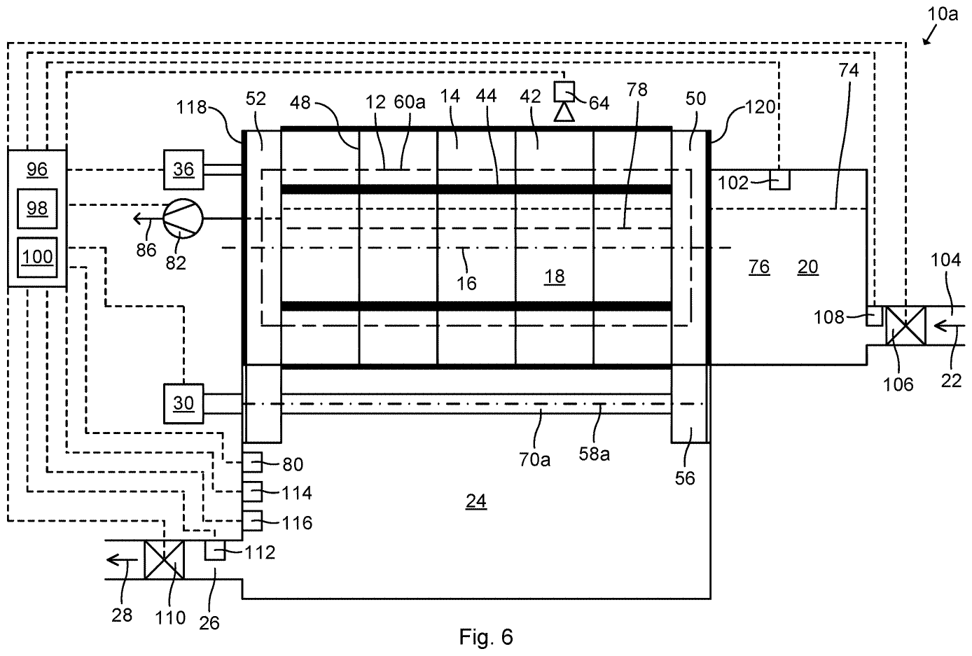

FIG. 6 schematically represents a further side view of the filtration apparatus 10a. The filtration apparatus 10a of this example further comprises a control system 96. The control system 96 comprises a data processing device 98 and a memory 100 having a computer program stored thereon. The computer program comprises program code which, when executed by the data processing device 98 causes the data processing device 98 to perform, or command performance of, various steps as described herein.

The upstream section 20 is here embodied as comprising an upstream tank open to atmosphere. The filtration apparatus 10a of this example further comprises an upstream level sensor 102 arranged to measure the upstream level 74 of the water 76 in the upstream section 20. and in the interior volume 18. The upstream level sensor 102 is in signal communication with the control system 96.

As shown in FIG. 6, the upstream section 20 of this example comprises an inlet line 104 for the inlet flow 22. The filtration apparatus 10 a of this example further comprises an inlet valve 106. The inlet valve 106 is configured to control the inlet flow 22. The inlet valve 106 is one example of a liquid inlet device for regulating the inlet flow 22. The inlet valve 106 is here positioned in the inlet line 104. The inlet valve 106 is in signal communication with the control system 96. By controlling the inlet valve 106 to open, or to open more from an arbitrary position, the upstream level 74 can be increased. As a consequence, the pressure in the upstream section 20 can be increased and the differential pressure over the active filter elements 42 can be increased.

The filtration apparatus 10a of this example further comprises an upstream flow sensor 108. The upstream flow sensor 108 is configured to measure a flow of water 76 in the upstream section 20, here in the inlet line 104. The upstream flow sensor 108 is in signal communication with the control system 96. The upstream flow sensor 108 may be used as an alternative to, or a complement to, the upstream level sensor 102.

Also the cleaning device 64 and/or the feed motor 36 may be in signal communication with the control system 96.

The vacuum pump 82 is in signal communication with the control system 96. The control system 96 can control a speed of the vacuum pump 82, for example by means of a variable frequency drive. By controlling the vacuum pump 82 to increase the gas flow 86, the pressure in the downstream tank 24 can be decreased and the differential pressure over the active filter elements 42 can consequently be increased.

The drive motor 30 is in signal communication with the control system 96. The control system 96 can control a speed of the drive motor 30 to thereby control a rotational speed of the drum 14. By controlling the drive motor 30, the differential pressure over the filter elements 42 can be controlled. For example, a slower rotational speed of the drum 14 causes an increased accumulation of residue on the filter elements 42 per rotation. Consequently, a decrease in rotational speed of the drum 14 causes the differential pressure of the filter elements 42 to be increased.

Except for the outlet line 26 and the vacuum pump 82, the downstream tank 24 of this example is closed to atmosphere. FIG. 6 further shows the downstream level sensor 80 arranged to measure the downstream level 78 of the water 76 in the downstream tank 24. The downstream level sensor 80 is in signal communication with the control system 96.

The filtration apparatus 10a of this example further comprises an outlet valve 110. The outlet valve 110 is configured to control the outlet flow 28. The outlet valve 110 is one example of a liquid outlet device according to the present disclosure. The outlet valve 110 is here positioned in the outlet line 26. The outlet valve 110 is in signal communication with the control system 96. By controlling the outlet valve 110 to open, or to open more from an arbitrary position, the downstream level 78 can be decreased. As a consequence, the pressure in the upstream section 20 can be decreased and the differential pressure over the active filter elements 42 can consequently be increased.

The filtration apparatus 10a of this example further comprises a downstream flow sensor 112. The downstream flow sensor 112 is configured to measure the outlet flow 28 of water 76 out from the downstream tank 24, here in the outlet line 26. The downstream flow sensor 112 is in signal communication with the control system 96. The downstream flow sensor 112 may be used as an alternative to, or a complement to, the downstream level sensor 80.

The filtration apparatus 10a of this example further comprises a pressure sensor 114, here positioned in the downstream tank 24. The pressure sensor 114 is configured to monitor an underpressure of the water 76 in the downstream tank 24. The pressure sensor 114 is in signal communication with the control system 96.

The filtration apparatus 10a of this example further comprises a temperature sensor 116. The temperature sensor 116 of this example is arranged in the downstream tank 24. By means of the temperature sensor 116, a temperature of the water 76 in the downstream tank 24 can be monitored. The temperature sensor 116 is in signal communication with the control system 96.

FIG. 6 further shows that the filtration apparatus 10a of this example comprises a first end seal 118 and a second end seal 120. The first end seal 118 is arranged to seal between the first end 50 and the base structure 12. The second end seal 120 is arranged to seal between the second end 52 and the base structure 12.

The control system 96 is arranged to control a differential pressure over the active filter elements 42. To this end, the control system 96 may for example control the inlet valve 106, the vacuum pump 82, the drive motor 30 and/or the outlet valve 110. Moreover, for this control, the control system 96 may use as feedback, signals from one, several or all of the upstream flow sensor 108, the upstream level sensor 102, the downstream flow sensor 112, the downstream level sensor 80, the pressure sensor 114 and the temperature sensor 116. The differential pressure may for example be controlled based on rotational speed of the drum 14.

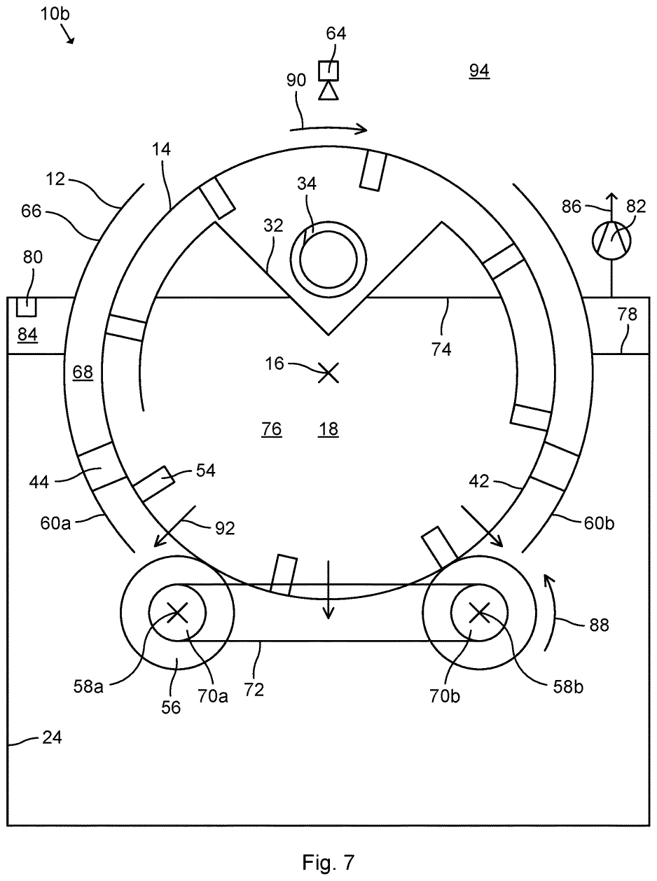

FIG. 7 schematically represents a cross-sectional end view of a filtration apparatus 10b according to a further example. Mainly differences with respect to the filtration apparatus 10a will be described. The filtration apparatus 10b differs from the filtration apparatus 10a in that in the filtration apparatus 10b, the sealing elements 44 are fixed to the base structure 12 instead of to the drum 14. In this example, the filtration apparatus 10b comprises one sealing element 44 sealingly closing between the base structure 12, here the first base element 60a thereof, and the drum 14, and one sealing element 44 sealingly closing between the base structure 12, here the second base element 60b thereof, and the drum 14. In the 12 of this example, each base element 60a, 60b comprises only a curved portion 66.

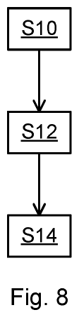

FIG. 8 is a flowchart outlining general steps of a method of controlling a filtration apparatus 10a; 10b. The method comprises providing S10 a filtration apparatus 10a; 10b comprising a stationary base structure 12; a drum 14 comprising a central drum axis 16 and being rotatable inside and relative to the base structure 12 about the drum axis 16, the drum 14 defining an interior volume 18 for receiving liquid 76 from an upstream section 20 and comprising at least one filter element 42 for filtering liquid 76 passing from the interior volume 18 to a downstream tank 24 downstream of the drum 14; and a plurality of sealing elements 44 arranged to seal radially between the drum 14 and the base structure 12 with respect to the drum axis 16 in each rotational position of the drum 14 with respect to the drum axis 16. The method further comprises conducting S12 a liquid 76 through the at least one filter element 42 while rotating the drum 14 around the drum axis 16. The method further comprises controlling S14 a differential pressure of the liquid 76 through the at least one filter element 42.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A filtration apparatus for filtering liquid, the filtration apparatus comprising:
a stationary base structure;
a drum comprising a central drum axis and being rotatable inside and relative to the base structure about the drum axis the drum defining an interior volume for receiving liquid from an upstream section and comprising at least one filter element for filtering liquid passing from the interior volume to a downstream tank downstream of the drum; and
a plurality of sealing elements arranged to seal radially between the drum and the base structure with respect to the drum axis in each rotational position of the drum with respect to the drum axis.

2. The filtration apparatus according to claim 1, wherein each sealing element is elongated and oriented substantially parallel with the drum axis.

3. The filtration apparatus according to claim 1, further comprising the downstream tank, wherein the filtration apparatus configured to provide an underpressure in the downstream tank with respect to an atmospheric pressure.

4. The filtration apparatus according to claim 3, further comprising a liquid outlet device configured to control an outlet flow of the liquid out from the downstream tank, and a gas outlet device configured to control a gas flow out from the downstream tank.

5. The filtration apparatus according to claim 1, wherein the sealing elements are fixed to the drum.

6. The filtration apparatus according to claim 1, wherein the base structure comprises a first base element and a second base element on opposite sides of the drum, and wherein the sealing elements seal radially between the drum and the base elements.

7. The filtration apparatus according to claim 6, wherein each base element has an angular extension with respect to the drum axis that is equal to, or larger than, a maximum angular extension between two adjacent sealing element with respect to the drum axis.

8. The filtration apparatus according to claim 6, wherein each base element comprises a plate.

9. The filtration apparatus according to claim 6, wherein for one of the base elements, the base element comprises a bulge protruding away from the drum axis such that for at least one rotational position of the drum with respect to the drum axis, two of the sealing elements are in contact with the base element on opposite sides of the bulge.

10. The filtration apparatus according to claim 6, wherein for each rotational position of the drum about the drum axis, two of the sealing elements sealing radially between the drum and the base elements are positioned below the drum axis.

11. The filtration apparatus according to claim 1, wherein the drum comprises a first end and a second end along the drum axis wherein each filter element is positioned between the first end and the second end, and wherein each sealing element and the base structure extend substantially in parallel with the drum axis from the first end to the second end.

12. The filtration apparatus according to claim 1, further comprising at least one wheel, each wheel being rotatable about a wheel axis substantially parallel with the drum axis, wherein the drum rests on the at least one wheel.

13. The filtration apparatus according to claim 12, further comprising a drive motor arranged to drive the at least one wheel about the respective wheel axis for rotating the drum about the drum axis.

14. A method of controlling a filtration apparatus, the method comprising:
providing filtration apparatus;
conducting a liquid through the at least one filter element while rotating the drum around the drum axis; and
controlling a differential pressure of the liquid through the at least one filter element,
wherein the filtration apparatus comprises:
a stationary base structure,
a drum comprising a central drum axis and being rotatable inside and relative to the base structure about the drum axis, the drum defining an interior volume for receiving the liquid from an upstream section and comprising at least one filter element for filtering the liquid passing from the interior volume to a downstream tank (24) downstream of the drum, and
a plurality of sealing elements arranged to seal radially between the drum and the base structure with respect to the drum axis in each rotational position of the drum with respect to the drum axis.

15. The method according to claim 14, wherein the control of the differential pressure comprises controlling a rotational speed of the drum about the drum axis.

16. The method according to claim 14, wherein the filtration apparatus further comprises the downstream tank, wherein the filtration apparatus is configured to provide an underpressure in the downstream tank with respect to an atmospheric pressure, and wherein the control of the differential pressure comprises controlling the liquid outlet device to control the outlet flow and/or controlling the gas outlet device to control the gas flow.
